(19) United States
(12) Patent Application Publication
(10) Pub. No.: US 2008/0193215 A1
(43) Pub. Date: Aug. 14, 2008

(54) Boom Sprayer Apparatus

(76) Inventor: Christian Rath, Crown Point, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/833,513

(22) Filed: Aug. 3, 2007

Related U.S. Application Data
(60) Provisional application No. 60/889,680, filed on Feb. 13, 2007.

(51) Int. Cl. E01C 19/16; B05B 1/20

(52) U.S. Cl. 404/111; 239/159

(57) ABSTRACT

An apparatus or a vehicle for applying multiple coatings of fluid to a surface in a single moving pass comprises a manifold having a plurality of nozzles. A first nozzle applies a first layer of fluid to the surface in accordance with a first spray pattern. A second nozzle carried applies a second layer of fluid to the surface in accordance with a second spray pattern. The second layer substantially covers the first layer. A third nozzle applies a third layer of fluid to the surface in accordance with a third spray pattern. The third layer substantially covers the first and second layers. The apparatus provides for multiple coatings of one or more fluids onto a substrate in a single pass, whereby the application of the various layers is accurately controlled to achieve a desired result.

### CROSS-REFERENCE TO RELATED APPLICATIONS

Applicant hereby claims the priority benefit of U.S. Provisional Patent Application No. 60/889,680, filed Feb. 13, 2007, the entire contents of which are incorporated herein by reference.

### FIELD OF THE INVENTION

The present invention generally relates to an apparatus for the application of a solution onto a surface, and more particularly, to a multi-nozzle apparatus for spraying a solution onto the ground from a moving vehicle.

### BACKGROUND

It is generally well known that various surfaces, such as asphalt, concrete, or dirt roads, often require a solution to be applied to increase the useful life of the surface. For example, often times an oil is sprayed over the surface of a dirt road to reduce dust accumulation. Other times tar is sprayed over the surface of an asphalt road or a sealant is applied to a concrete road or driveway to help sustain against the elements such as wind, water, ice, snow, salt, etc.

One known device for applying such oil, tar, and/or sealant comprises a motor vehicle equipped with a tank and a sprayer. The tank stores the fluid to be sprayed, i.e., the oil, tar, or sealant. The sprayer is typically suspended from the rear of the vehicle such that while the vehicle drives forward, the sprayer applies the fluid to the application surface 1, i.e., the road, driveway, etc. Generally speaking, the sprayers that are equipped on such known devices comprise a manifold and one or more nozzles. The manifold is in fluid communication with the tank via a pump, or some other supplying means. The nozzles are coupled to the manifold in a manner that they each emit a generally uniform spray to cover the entire application surface 1. For example, the manifold may comprise a generally horizontal pipe disposed from the rear of the truck which is preferably substantially as long as the truck is wide. In one known form, the nozzles comprise uniformly sized openings formed in the bottom-side of the manifold and equally spaced along the length thereof.

Accordingly, as the vehicle travels along the application surface 1, the nozzles provide a plurality of independent spray patterns that meet with each other, but preferably do not significantly overlap. Thus, the nozzles provide a substantially uniform application of the fluid onto the surface. In other known examples, the manifold may comprise a plurality of horizontally configured tubes interconnected to provide an array-type application sprayer. In such a configuration, each of the manifolds is disposed at approximately the same height above the application surface 1 to ensure proper application. Similar to the example discussed above, such an array-type system provides a plurality of spray patterns meeting with each other, but preferably not significantly overlapping.

While the above-described sprayer devices have generally served their purpose of applying a single, generally uniform coat of a fluid onto a surface, more complex applications may require more complex devices.

For example, one recent innovation for the suppression of dust on roads, in deserts, and air-fields, etc., has been to apply a water-soluble polymer to the surface thereof. Such an innovation is described in U.S. patent application Ser. No. 11/298,269 entitled “Method of Dust Abatement,” which is hereby incorporated herein by reference. Water soluble polymer formulations are generally provided as a liquid solution or emulsion, for example, comprising a polymer diluted with water. In theory, after the solution or emulsion is sprayed over a surface, the water evaporates, thereby allowing the polymer to solidify and bind small particulates on the surface and into some depth of the substrate, thereby forming a polymer-particle composite. The spraying application of these solutions, however, often requires multiple applications to ensure proper coverage, polymer loading, depth of penetration, and other desired results. Accordingly, to apply such films with the aforementioned known devices can sometimes require multiple passes by one or more sprayer trucks.

However, the integrity of early applications of the polymer can structurally sensitive, and therefore, each subsequent pass by the truck has the potential to disturb the previously applied polymer, thereby disrupting the integrity of the composite. Moreover, the timing between the application of each layer of film can be sensitive depending on the mixture of the solution. For example, it can be important to apply a subsequent layer within a certain time duration after the application of the preceding layer such that the preceding layer has an opportunity to penetrate the surface but not completely dry, for example.

### SUMMARY

One embodiment of the present invention includes an apparatus for applying multiple coatings of liquid onto an application surface in a single pass. The apparatus comprises a manifold, a first nozzle, a second nozzle, and a third nozzle. The first nozzle is coupled to a first outlet of the plurality of outlets, and is disposed at a first angle relative to a plane that is one of parallel and perpendicular to the application surface. The second nozzle is coupled to a second outlet of the plurality of outlets, and is disposed at a second angle relative to the plane. The third nozzle is coupled to a third outlet of the plurality of outlets, and is disposed at a third angle relative to the plane. In at least one embodiment, the first, second, third angles are all different.

### BRIEF DESCRIPTION OF THE DRAWINGS

FIG. 1 is a schematic representation of a top view of a motor vehicle equipped with a sprayer apparatus constructed in accordance with the principles of the present invention emitting one example of multiple spray patterns;

FIG. 2 depicts a rear view of a sprayer apparatus constructed in accordance with a first embodiment of the present invention configured in operable connection with a motor vehicle;

FIG. 3 depicts a side view of the sprayer apparatus of FIG. 2;

FIG. 4 is a schematic side view of the sprayer apparatus of FIGS. 2 and 3 during operation;

FIG. 5 is a schematic side view of an alternative configuration of the sprayer apparatus of FIGS. 2 and 3;

FIG. 6 depicts a side view of a sprayer apparatus constructed in accordance with a second embodiment of the present invention;

FIG. 7 depicts a rear view of a sprayer apparatus constructed in accordance with a third embodiment of the present invention configured in operable connection with a motor vehicle;

FIG. 8 depicts a side perspective view of the sprayer apparatus of FIG. 6; and

FIG. 9 depicts a rear view of a sprayer apparatus constructed in accordance with a fourth embodiment of the present invention.

### DETAILED DESCRIPTION

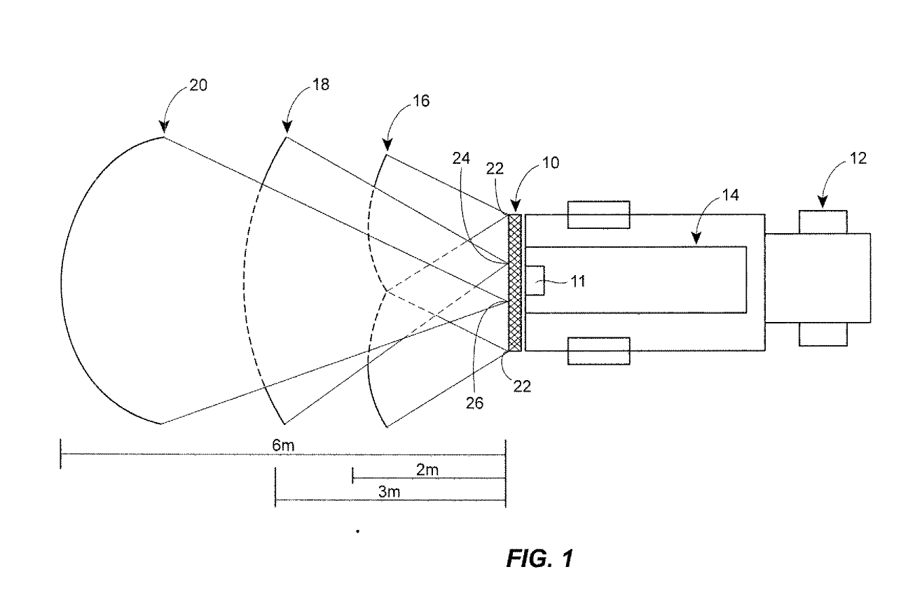

FIG. 1 provides a schematic representation of a boom sprayer apparatus 10 (hereinafter “boom 10”) constructed in accordance with the principles of the present invention. It should be appreciated that while the boom 10 is represented as being disposed generally horizontally relative to an application surface 1 in FIG. 1, this is merely a schematic representation to illustrate the spray patterns generated from the boom 10. For example, as depicted, the boom 10 is attached to a motor vehicle (e.g., truck) 12, which is designed to carry a supply tank 14. The supply tank 14 is adapted to contain a fluid such as an aqueous solution of water soluble polymer for example, to be applied to the application surface 1. The supply tank 14 is therefore operably attached to the boom 10 via a pump 11 such as a power take-off pump.

As illustrated in FIG. 1 and during operation, while the truck 12 is moving forward, i.e., to the right relative to the orientation of FIG. 1, the boom 10 emits a first stage spray pattern 16, a second stage spray pattern 18, and a third stage spray pattern 20. The first stage spray pattern 16 is configured such that it applies a first layer of fluid on the application surface 1 (e.g., the driving surface). The second stage spray pattern 18 is disposed such that it applies a layer of fluid to the application surface 1 that substantially covers the layer of fluid applied by the first stage spray pattern 16, as the truck 12 travels forward. Finally, the third stage spray pattern 20 is disposed such that it applies a layer of fluid to the application surface 1 that substantially covers the layers of fluid applied by both the first and second stage spray patterns 16, 18, as the truck 12 travels forward. In the disclosed embodiment, if the boom 10 were activated with the truck 12 at a stand-still, the first stage spray pattern 16 includes a range of approximately two meters, the second stage spray pattern 18 includes a range of approximately three meters, and the third stage spray pattern 20 includes a range of approximately six meters. Therefore, the boom 10 advantageously applies three layers of fluid to the application surface 1 with a single moving pass of the truck 12.

In the illustrated form, the first stage spray pattern 16 is generated from two separate nozzles 22 on the boom 10, while the second and third spray patterns 18, 20 are each generated from single nozzles 24 and 26, respectively. However, it should be appreciated that the various spray patterns 16, 18, 20 may be generated from generally any number of nozzles, as may be desired for any given application.

Nevertheless, in the disclosed embodiment, the nozzles 22, 24, 26 are designed such that each of the first, second, and third stage spray patterns 16-20 have characteristic droplet sizes. For example, the nozzles 22 for emitting the first stage spray pattern 16 generate a stream, preferably a mist with a small droplet size, relative to the others. The nozzle 24 for emitting the second stage spray pattern 18 generates a stream, preferably a mist having a medium droplet size, relative to the others. The nozzle 26 for emitting the third stage spray pattern 20 generates a stream or mist having a large droplet size, relative to the others. The relative sizes of the droplets in each of the first, second, and third stage spray patterns 16, 18, 20 provide for the appropriate quantities of fluid for the application process. For example, the small droplets in the mist generated for the first stage spray pattern 16 can provide a pre-wetting function that serves to break the surface tension of the dust or soil on the application surface 1. The medium droplets of the second stage spray pattern 18 serve as a first main application of the fluid onto the application surface 1. Finally, the largest droplets of the third stage spray pattern 20 serve as a second main application of the fluid, after the first main application has had some opportunity to penetrate the application surface 1.

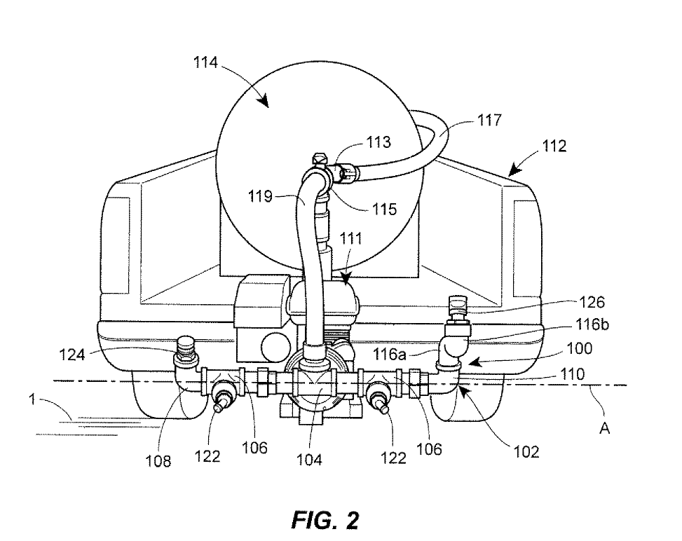

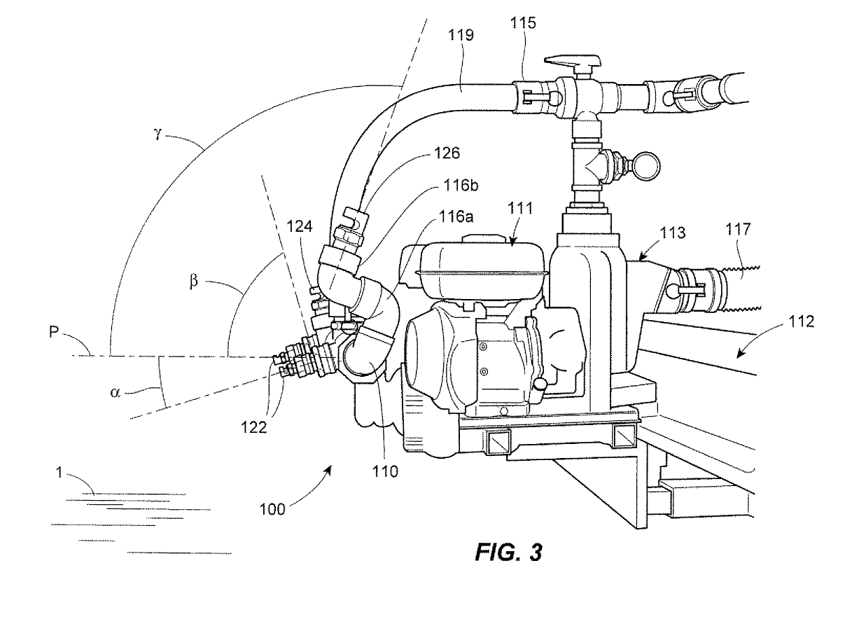

With reference to FIGS. 2 and 3, a first embodiment of a boom 100 constructed in accordance with the principles of the present invention will be described. As depicted, the boom 100 is operably connected to a truck 112, which carries a tank 114 (shown in FIG. 2) and a pump 111. The tank 114 is adapted to store a fluid such as a water soluble polymer solution for application onto an application surface 1. The pump 111 comprises an input 113 and an output 115. The input 113 is fluidly coupled to the tank 114 via a fluid line 117. The output 115 is fluidly coupled to the boom 100 via a fluid line 119. The pump 111 is therefore adapted to move the fluid from the tank 114 to the boom 100 for application to the application surface 1.

The boom 100 of the embodiment depicted in FIGS. 2 and 3 is capable of performing similar to the boom 10 described above with reference to FIG. 1. The boom 100 is oriented generally horizontal, relative to the application surface 1. Additionally, the boom 100 comprises a manifold 102, first stage nozzles 122, a second stage nozzle 124, and a third stage nozzle 126. The first, second, and third stage nozzles 122, 124, 126 are adapted to provide first, second, and third stage spray patterns 16, 18, 20, respectively, similar to those described above with reference to FIG. 1.

The manifold 102 includes a major axis A, which in the disclosed embodiment constitutes the longitudinal axis of the manifold 102. Additionally, the manifold 102 comprises a generally elongated horizontal pipe portion 104, a pair of first stage extensions 106, a second stage elbow. 108, and a third stage elbow 110. The second stage elbow 108 and the third stage elbow 110 are disposed on opposite ends of the manifold 102. Generally speaking, the manifold 102 and the rest of the boom 100 is constructed of generally available pipe fittings and components of various sizes. In the depicted example, the components are generally two-inch or one and one-half-inch in diameter, with the exception of the first stage extensions 106, which can be one-half-inch in diameter.

The first stage nozzles 122 are threadably coupled to the first stage extensions 106. The second stage nozzle 124 is threadably coupled to the second stage elbow 108. Moreover, the third stage nozzle 126 is threadably coupled to the third stage elbow 110 via first and second intermediate elbows 116a, 116b. So configured, and as depicted in FIG. 3, for example, the second stage nozzle 124 is disposed higher above the application surface 1 than the first stage nozzles 122, and the third stage nozzle 126 is disposed higher above the application surface 1 than the second stage nozzle 124.

With reference to FIG. 3, in the disclosed embodiment, the first stage extensions 106 extend at an angle a that is in the range of approximately 1° to approximately 30°, and preferably approximately 20° below a horizontal plane P, which is shown in FIG. 3. The plane P extends through and includes the major axis A of the manifold 102 and is disposed generally parallel to the application surface 1. Accordingly, the first stage nozzles 122 are also directed at the angle α that is in the range of approximately 1° to approximately 30°, and preferably approximately 20°, below the plane P. Moreover, the second stage elbow 108, and therefore, the second stage nozzle 124 is disposed at an angle β that is in the range of approximately 30° to approximately 85°, and preferably approximately 75°, above the plane P. Further still, the third stage nozzle 126 is disposed at an angle γ that is in the range of approximately 95° to approximately 130°, and preferably approximately 115°, above the plane P. Accordingly, in the embodiment depicted in FIGS. 2 and 3, the first stage nozzles 122 advantageously provide a first spray pattern similar to the first stage spray pattern 16 depicted in FIG. 1, as the truck 112 moves forward along the application surface 1. The second stage nozzle 124 advantageously provides a spray pattern similar to the second stage spray pattern 18 and the third stage nozzle 126 advantageously provides a spray pattern similar to the third stage spray pattern 20. Moreover, due to the relative heights and angles of each of the spray nozzles 122, 124, 126 depicted in FIGS. 2 and 3, the spray patterns 16, 18, 20 are emitted from the boom 100 at relative angles.

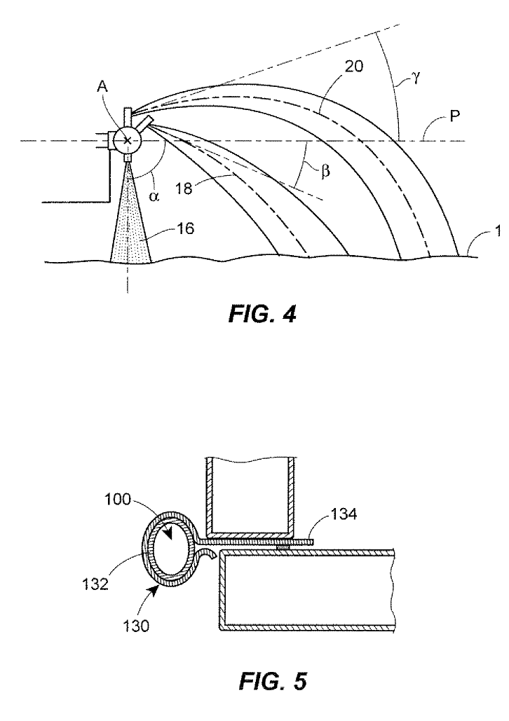

For example, in the alternative embodiment depicted in FIG. 4, a first stage spray pattern 16 is generally directly at an angle α relative to a plane P that extends through and includes a major axis A of the manifold 102 and is disposed parallel to the application surface 1. In the embodiment depicted in FIG. 4, the angle α is approximately 90° below the plane P. On the contrary, a second stage spray pattern 18 is directed at an angle β below the plane P, and a third stage spray pattern 20 is directed at an angle γ above the plane P. The angle β is in the range of approximately 5° to approximately 60°, and in one embodiment, approximately 30°. Moreover, in the disclosed embodiment, the angle γ is in the range of approximately 5° to approximately 60°, and in one embodiment, approximately 30°. Thus, as depicted, the angles α,β of the first and second stage spray patterns 16, 18 may be considered negative angles relative to the plane P, while the angle y of the third stage spray pattern 20 may be considered a positive angle. It should be appreciated that the emission angles α, β, γ of the first, second, and third stage spray patterns 16, 18, 20, respectively, may be obtained by any of the booms described herein, including the booms described below.

In the embodiment of the boom 100 disclosed with reference to FIGS. 2 and 3, the first stage nozzles 122, the second stage nozzle 124, and the third stage nozzle 126 preferably have outputs in the range of approximately 12 gallons per minute (gpm) (45 liters per minute (lpm)) to approximately 125 gpm (473 lpm) at a pressure of approximately 30 pounds per square inch (psi) (206 kilopascals (kpa)) and creating a droplet size in the range of approximately 50 microns (μm) to approximately 335 microns. For example, one embodiment of the first stage nozzles 122 may include BETE MP 1312 NN nozzles designed to emit a full cone-shaped spray with a dispersion angle of approximately 30°, an output of approximately 13 gpm (49 lpm) at approximately 30 psi (206 kpa), and a droplet size of 50 microns. The second stage nozzle 124 for emitting a spray pattern similar to the second stage spray pattern 18 may comprise a BETE FF 703 nozzle for emitting a fan-shaped spray with a dispersion angle of approximately 145°, an output of approximately 78 gpm (295 lpm) at approximately 30 psi (206 kpa), and a droplet size of approximately 185 microns. The third stage nozzle 126 for emitting a spray pattern similar to the third stage spray pattern 20 may comprise a BETE FF 750 nozzle for emitting a fan-shaped spray with a dispersion angle of approximately 145°, an output of approximately 130 gpm (492 lpm) at approximately 30 psi (206 kpa), and a droplet size of approximately 335 microns. Each of these nozzles is commercially available from BETE Fog Nozzle, Inc. of Greenfield Mass., USA.

It should be appreciated that the above-described configuration of nozzles is merely one example and that any configuration of nozzles capable of serving one or more of the principles described herein may be utilized. For example, in one alternative embodiment, the first stage nozzles 122 may include BETE 1312 N nozzles having an output of approximately 12 gpm (45 lpm) at a pressure of approximately 30 psi (206 kpa) and creating a droplet size of approximately 50 microns. In another alternative embodiment, the first stage nozzles 122 may include BETE TF20170 nozzles having an output of approximately 14.3 gpm (54 lpm) at a pressure of approximately 30 psi (206 kpa) and droplet size of 50 microns. In a still further alternative embodiment, the second stage nozzle 124 may include a BETE FF 750 nozzle having an output of approximately 91 gpm (344 lpm) at a pressure of approximately 30 psi (206 kpa) and creating a droplet size of approximately 185 microns. Accordingly, it should be appreciated that in the disclosed embodiment, the second stage spray nozzle 124 produces droplets larger than the first stage spray nozzles 122, and the third stage spray nozzle 126 produces droplets larger than the second stage spray nozzle 124.

While the boom 100 is generally depicted in FIGS. 2 and 3 as being disposed on a platform that supports the pump 111, alternative implementations can be used. For example, in one alternative embodiment, the pump 111 may be supported directly within the bed of a pick-up truck, and therefore, there would be no platform needed to support the boom 100. Accordingly, as depicted in FIG. 5, the boom 100 can be equipped with an anchor 130. The anchor 130 may comprise a sleeve portion 132 and an arm portion 134. The sleeve portion 132 wraps around all or a portion of the manifold 102 of the boom 100. The arm portion 134 therefore extends outward from the boom 100 and may be supported between a pick-up truck bed and a tailgate, as illustrated. The anchor 130 therefore effectively cantilevers the boom 100 off of the back of the truck.

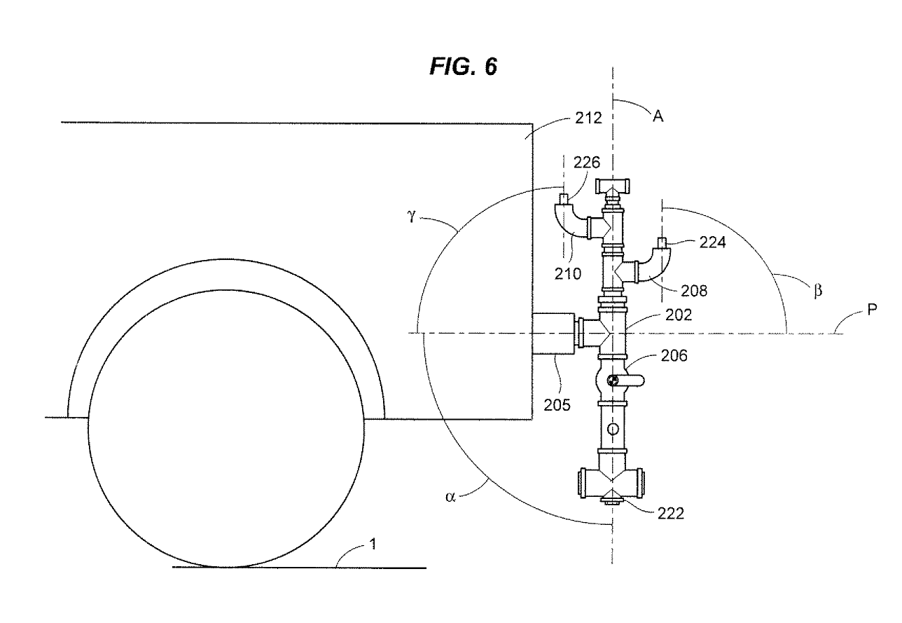

FIG. 6 illustrates another embodiment of a boom 200 constructed in accordance with the principles of the invention. Unlike the boom 100 described above, the boom 200 depicted in FIG. 6 is adapted to be oriented generally perpendicular, relative to the application surface 1. Nevertheless, the boom 200 operates substantially similar to the boom 100 depicted and described above.

The boom 200 generally comprises a manifold 202, a first stage nozzle 222, a second stage nozzle 224, and a third stage nozzle 226. The manifold 202 includes a major axis A, which constitutes the longitudinal axis of the manifold 202, and which is oriented perpendicular to the application surface 1. Moreover, the boom 200 comprises a second stage elbow 208 and a third stage elbow 210. The second stage nozzle 224 is threadably coupled to the second stage elbow 208, which is coupled to the manifold 202. The third stage nozzle 226 is threadably coupled to the third stage elbow 210, which is also coupled to the manifold 202. In one embodiment, the second and third stage nozzles 224, 226 are aligned generally parallel to the major axis A of the manifold 202. The first stage nozzle 222 is directly coupled to the bottom of the manifold 202, as oriented in FIG. 6, and therefore aligned with the major axis A of the manifold 202. The manifold 202 is attached to a truck 212, which carries a tank (not shown) and a pump (not shown) for providing a supply of fluid to the boom 200.

Accordingly, the second stage nozzle 224 is disposed higher above the application surface 1 than the first stage nozzle 222, and the third stage nozzle is disposed higher above the application surface 1 than the second stage nozzle 224. Moreover, the first stage nozzle 222 can be oriented substantially directly downward from the manifold 202 such that the first stage nozzle 222 emits a spray pattern generally perpendicular to the spray patterns of the second and third stage nozzles 224, 226. For example, as depicted in FIG. 6, the second and third stage nozzles 224, 226 are adapted to emit a spray pattern in a direction directly behind the truck 212, i.e., to the right of FIG. 6, whereas, as mentioned, the first stage nozzle 222 is adapted to emit a spray pattern generally directly downward onto the application surface 1. For the sake of description, FIG. 6 illustrates a plane P that is disposed perpendicular to the major axis A of the manifold 202 and parallel to the application surface 1. The first, second, and third stage nozzles 222, 224, 226 are disposed at respective angles α, β, γ, each of which is approximately 90° relative to the plane P. The second and third stage nozzles 224, 226 are disposed at angles β, γ of approximately 90° above the plane P, while the first stage nozzle 222 is disposed at an angle a that is approximately 90° below the plane P.

In alternative embodiments, the second and third stage nozzles 224, 226 can be disposed at different angles relative to the plane P. For example, in one embodiment, the second and third stage nozzles 224, 226 may be disposed at angles similar to angles β and γ described above with reference to the nozzles of the boom 100 depicted in FIGS. 2 and 3, wherein γ corresponds to the angle of the third stage nozzle 126 and β corresponds to the angle of the second stage nozzle 124. In any configuration, during operation, the boom 200 is adapted to emit first, second, and third stage spray patterns 16, 18, 20 similar to those depicted in FIG. 1 or FIG. 4 with the exception that the first stage spray pattern 16 is generated by the single first stage nozzle 222.

Additionally, the boom 200 depicted in FIG. 6 comprises a shut-off valve 214 and a quick-couple inlet 205. The shut-off valve 214 is operable to shut-off the flow of fluid through the manifold 202 to the first stage nozzle 222. The quick-couple inlet 205 comprises a manually operable disconnect mechanism, such as a threaded disconnect mechanism or some other mechanism, for attaching and detaching the boom 200 to and from a fluid line from a pump, such as pump 111 described above with reference to FIGS. 2 and 3.

While no specific commercialized nozzles have been specified herein for the first, second, and third stage 222, 224, 226 nozzles of the boom 200 depicted in FIG. 6, the boom 200 may be designed in a variety of ways to include virtually any combination of commercialized or custom nozzles, including those nozzles described above with reference to the boom 100 depicted in FIGS. 2 and 3.

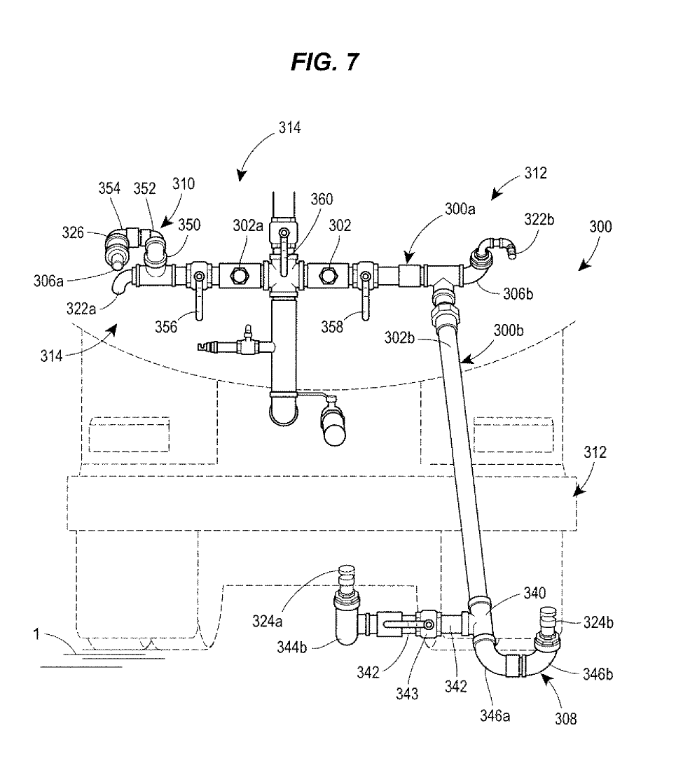

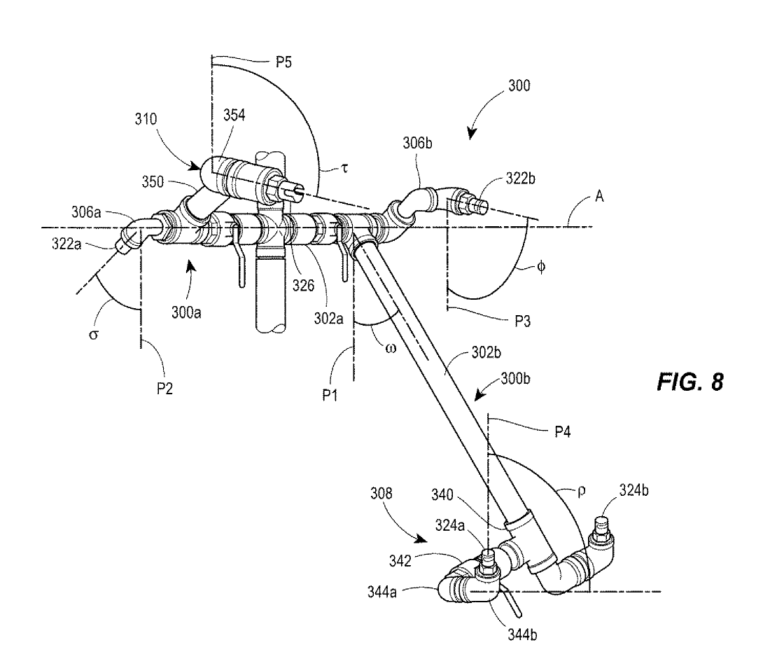

FIGS. 7 and 8 depict a third embodiment of a boom 300 attached to a truck 312 for spraying a fluid contained in a tank 314 which is mounted on the truck 312. Unlike the booms 100, 200 described above, the boom 300 depicted in FIGS. 7 and 8 includes a horizontal portion 300a and an inclined portion 300b that are generally perpendicular to each other. Nevertheless, the boom 300 can operate similar to the booms 100, 200 described above, as will be described.

The boom 300 generally comprises a manifold 302, a pair of first stage nozzles 322a, 322b, a pair of second stage nozzles 324a, 324b, and a third stage nozzle 326. The manifold 302 comprises a horizontal component 302a and a transverse component 302b. The manifold 302 includes a major axis A (shown in FIG. 7), which also constitutes the longitudinal axis of the horizontal component 302a of the manifold 302, and which is disposed parallel to the application surface 1. The transverse component 302b extends generally downward from the horizontal component 302a. Additionally, in the disclosed embodiment, the transverse component 302b is inclined relative to the application surface 1 and extends slightly rearward, relative to the truck 312, of the horizontal component 302a at an angle ω (shown in FIG. 8) that is in the range of approximately 15° to approximately 45°, and preferably approximately 30° rearward of a vertical plane P1 depicted in FIG. 8. Plane P1 extends through and includes the major axis A of the manifold 302 and is disposed perpendicular to the application surface 1. Further, as depicted in FIGS. 7 and 8, the first stage nozzles 322 are disposed at a height above the application surface 1 that is higher than the second stage nozzles 324, and the third stage nozzle 326 is disposed at a height that is higher than the first stage nozzles 322.

The boom 300 also comprises a pair of first stage elbows 306a, 306b, a second stage assembly 308, and a third stage assembly 310 for attaching the first, second, and third stage nozzles 322, 324, 326, respectively, to the manifold 302. The first stage nozzles 322a, 322b are threadably coupled to the first stage elbows 306a, 306b, respectively, thereby fluidly coupling the first stage nozzles 322a, 322b to opposing ends of the horizontal component 302a of the manifold 302, as depicted. In the disclosed embodiment, the first stage nozzles 322a, 322b are both disposed generally downward, toward the application surface 1, from the horizontal component 302a of the manifold 302. However, in the form depicted, first stage nozzle 322a is also disposed at an angle σ relative to a vertical plane P2 extends through and includes the major axis A of the manifold 302 and is disposed perpendicular to the application surface 1. The angle σ is in the range of approximately 15° to approximately 60°, and preferably approximately 45°. The first stage nozzle 322b is disposed at an angle φ relative to a vertical plane P3 that extends through and includes the major axis A of the manifold 302 and is disposed perpendicular to the application surface. The angle φ is in the range of approximately 45° to approximately 85°, and preferably approximately 75°.

The second stage assembly 308 is threadably coupled to an end of the transverse component 302b of the manifold 302 that is located distal to the horizontal component 302a. The second stage assembly 308 comprises a T-fitting 340, a delivery conduit 342, first transitional and terminal elbows 344a, 344b, and second transitional and terminal elbows 346a, 346b. In the disclosed embodiment, the T-fitting 340 is directly coupled to the distal end of the transverse component 302b of the manifold 302. The delivery conduit 342 is coupled to an outlet of the T-fitting 340 and extends generally horizontally to the side thereof, as depicted in FIG. 7, for example. Additionally, in one embodiment of the boom 300, the delivery conduit 342 can be generally parallel to the horizontal component 302a of the manifold 302 and, therefore, the application surface 1.

The first transitional and terminal elbows 344a, 344b are coupled to the end of the delivery conduit 342 opposite the T-fitting 340. The first transitional elbow 344a is disposed between the delivery conduit 342 and the first terminal elbow 344b. The first terminal elbow 344b is threadably coupled to second stage nozzle 324a, as depicted. The second transitional and terminal elbows 346a, 346b are coupled to the T-fitting 340 directly opposite the distal end of the transverse portion 302b of the manifold 302, as depicted in FIG. 7. The second transitional elbow 346a is disposed between the T-fitting 340 and the second terminal elbow 346b. Therefore, the second terminal elbow 346b is threadably coupled to the other of the second stage nozzles 324b. In the disclosed embodiment, the second stage nozzles 324a, 324b are disposed at a common angle ρ relative to a vertical plane P4 that is offset from the major axis A of the manifold 302, and is disposed parallel to planes P1-P3 and perpendicular to the application surface 1. In one embodiment, the angle ρ is approximately 90°. Additionally, as shown in FIG. 7, the sub-manifold 342 may include a valve 343 that allows for manual control of fluid flow to second stage nozzle 324a. Other valves, e.g., 356, 358, 360 can also be provided as desired to regulate the differential flow rates throughout the manifold 302.

The third stage assembly 310 comprises a nipple 350, a transitional elbow 352 (shown in FIG. 7), and a terminal elbow 354. The nipple 350 is coupled to the horizontal component 302a of the manifold 302. The transitional elbow 352 is coupled to the nipple 350 and is disposed between the nipple 350 and the terminal elbow 354. Accordingly, the third stage nozzle 326 is threadably coupled to the terminal elbow 354, as depicted in FIG. 8, for example. In the disclosed embodiment, the third stage nozzle 326 is directed substantially rearward of the truck 312 and slightly downward at an angle ι relative to a vertical plane P5 that extends through and includes the major axis A of the manifold 302 and is disposed perpendicular to the application surface 1. The angle ι is in the range of approximately 95° and approximately 125°, and preferably approximately 105°. While the various nozzles 322, 324, 326 of the boom 300 depicted in FIGS. 7 and 8 have been described as being disposed at various angles with respect to various vertical planes P1-P5, it should be appreciated that each of the planes P1, P2, P3, and P5 can be the same plane and plane P4 is offset from and parallel to planes P1, P2, P3, and P5. Thus, each of the nozzles 322, 324, 326 are disposed at their disclosed angles with respect to all of the planes P1-P5, i.e., although the second stage nozzles 344a-b have been described as being disposed at an angle ρ with respect to the vertical plane P4, they are also disposed at the same angle ρ relative to planes P1, P2, P3, and P5.

So configured, the boom 300 is adapted to provide three spray patterns generally in accordance with those depicted in FIG. 1 or FIG. 4. The first stage nozzles 322a, 322b are adapted to generate a spray pattern similar to the first stage spray pattern 16 described above with reference to FIG. 1 or FIG. 4, the second stage nozzles 324a, 324b are adapted to generate a spray pattern similar to the second stage spray pattern 18 described above, and the third stage nozzle 326 is adapted to generate a spray pattern substantially similar to the third stage spray pattern 20 described above.

It should be appreciated that the exact nozzles for use with the boom 300 just described may differ for any desired application. For example, in a preferred embodiment, wherein the boom 300 is used for applying a water soluble polymer solution, the first stage nozzles 322a may comprise BETE MP1312 NN nozzles having outputs of approximately 12.58 gpm (47 lpm) at approximately 30 psi (206 kpa) generating droplets of approximately 50 microns in size, for example, droplets having a D10 diameter of approximately 50 microns. Additionally, the second stage nozzles 324a, 324b preferably may comprise either BETE FF 703 nozzles or FF 750 nozzles, or one of each. BETE FF 703 nozzles and FF 750 nozzles have outputs of approximately 77.9 gpm (295 lpm) and approximately 90.9 gpm (344 lpm), respectively, at approximately 30 psi (206 kpa) and generate droplets of approximately 185 microns. Further still, the third stage nozzle 326 preferably may comprise a BETE NF 1500 nozzle having an output of approximately 130 gpm (492 lpm) at approximately 30 psi (206 kpa) and generating a droplet size of approximately 335 microns. Each of these nozzles is commercially available from BETE Fog Nozzle, Inc. of Greenfield Mass., USA.

While the first, second, and third stage nozzles 322, 324, 326 have been disclosed herein as being disposed at various angles relative to vertical planes P1-P5 identified in FIG. 8, alternative embodiments may include the nozzles 322, 324, 326 disposed at generally any desired or required angle for any given application. Furthermore, while the inclined component 302b of the manifold 302 has been disclosed herein as extending at an angle ω of preferably, approximately 30° from plane P1, alternative embodiments of the boom 300 may include a transverse component 302b that extends at generally any angle from the plane P1.

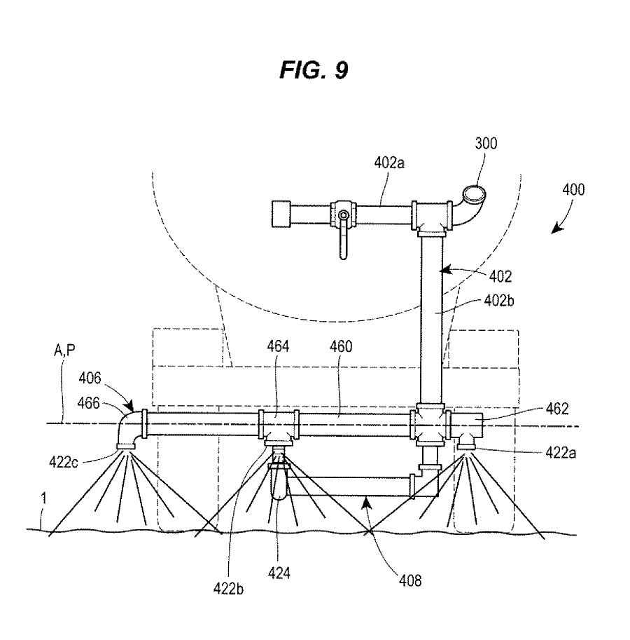

FIG. 9 depicts a fourth embodiment of a boom 400 constructed in accordance with the principles of the present invention. The boom 400 is substantially similar to the boom 300 described above with reference to FIGS. 7 and 8 except that the boom 400 comprises a first stage assembly 406 for accommodating a plurality of first stage nozzles 422a-c in a configuration that is distinct from the configuration of the first stage nozzles 322 described above. Additionally, the boom 400 comprises a second stage assembly 408 that is substantially similar to the second stage assembly 308 described above with reference to FIGS. 7 and 8, except that the second stage assembly 408 of FIG. 9 comprises a single second stage nozzle 424.

The first stage assembly 406 of the embodiment of the boom 400 depicted in FIG. 9 comprises a sub-manifold 460, a first elbow 462, a T-fitting 464, and a second elbow 466. The sub-manifold 460 includes a major axis A that also constitutes the longitudinal axis of the sub-manifold 460. Additionally, the sub-manifold 460 comprises a horizontal tubular member coupled to and extending transversely from the transverse component 402b of the manifold 402. More specifically, the sub-manifold 460 of the disclosed embodiment connects to the transverse component 402b at a location just slightly above the second stage assembly 408. As depicted, a first nozzle 422a is coupled to the first elbow 462, a second nozzle 422b is coupled to the T-fitting 464, and a third nozzle is coupled to the second elbow 466. In the disclosed embodiment, each of the first, second, and third nozzles 422a, 422b, 422c extend downward from the sub-manifold 460 at an angle of approximately 90° relative to a plane P that encompasses the major axis A of the sub-manifold 460 and is parallel to the application surface 1.

As mentioned, the boom 400 of FIG. 9 is similar to the boom 300 of FIGS. 7 and 8 and, therefore, the transverse component 402b of the boom 400 extends at the angle ω relative to vertical (as shown in FIG. 8). Accordingly, the first stage assembly 406 and the first stage nozzles 422a, 422b, 422c are disposed above and slightly toward the truck from the second stage nozzle 424. Nevertheless, the first stage nozzles 422a, 422b, 422c may be selected to generate a first stage spray pattern that is substantially identical or similar to the first stage spray pattern 16 depicted in FIG. 1, FIG. 4, or otherwise, in accordance with the present invention. In a preferred embodiment, the first stage nozzles 422a, 422b, 422c comprise BETE TF 20 nozzles having a 150° dispersion full cone spray, which are commercially available from BETE Fog Nozzle, Inc. of Greenfield Mass., USA.

While the various embodiments of the booms 100, 200, 300, 400 have been described herein as generally comprising one, two, or three nozzles for generating each of the first, second, and third stage spray patterns 16, 18, 20, as depicted in FIG. 1, alternative embodiments may include any number of nozzles for generating any or all of the spray patterns. Additionally, while the various embodiments of the booms 100, 200, 300, 400 have been disclosed herein as generating three different spray patterns, which thereby apply three layers of a fluid to a substrate in a single pass, alternative embodiments may include any number of spray patterns for applying any number of layers to a substrate in a single pass.

In light of the foregoing, it should be appreciated that the invention advantageously provides a compact, adaptable, boom sprayer apparatus that is capable of applying multiple layers of fluid to a single substrate such as a application surface 1 with a single pass. The boom sprayer apparatus comprises a relatively small front-to-back dimension, thereby having very minimal effect on the overall maneuverability of the truck to which it is attached. Moreover, the relative angles and heights of the various nozzles of the first, second, and third stages of application provide for distinct trajectories for each of the respective spray patterns, thereby achieving, e.g., in the disclosed embodiments, the result of multiple applications of a liquid in a single pass. Such a device therefore enables for the accurate application of multiple applications of solution to the substrate in a short time period of time without sacrificing the integrity of the substrate and any underlying application of liquid with subsequent passes by the sprayer truck. These advantages and other benefits have been substantiated by various experiments, as indicated by the following sets of test data.

For example, one test was conducted with the boom 100 described above with reference to FIG. 1. The test revealed that a preferred embodiment of the present invention designed for the application of water soluble polymer solutions includes the boom 100 connected to a commercial water truck with a power take-off pump with an output of 322 gpm (1218 lpm) at 750 rpm. In one case, the water soluble polymer solution was diluted according to a ratio of one part solution to three parts water. The speed of the truck was maintained at approximately 47 m/min (meters per minute) equivalent to 780 mm/sec (millimeters per second). The preferred time elapsed between the application of the fluid from the first stage nozzles 122 and the second stage nozzles 124 was approximately 1.3 seconds. The preferred time elapsed between the application of the fluid from the second stage nozzles 124 and the third stage nozzles 126 was approximately 3.8 seconds. Such timing allowed for the applied fluid to penetrate the application surface 1, which constituted sand, a sufficient amount prior to the application of the subsequent layer. The application rate of the water soluble film solution was 742 gallons per acre (gpa) (2808 liters per acre (lpa)). The total application rate was 642×4=2,968 gpa (11,235 lpa), of which 25% constituted the water soluble polymer solution and 75% constituted water. Other mixtures of water and polymer solution may be defined as warranted for the specific film solution. Accordingly, the first stage nozzles 122 provided a fine mist or prewetting. This prewetting operated to break the soil surface tension, thereby helping avoid puddles. With a system designed, configured, and operated as described, coverage may vary from 6,200 m²/h up to 12,400 m²/h.

In addition to the above-described test, other tests were conducted using different parameters and for the sake of completeness, the results of these tests are summarized in Tables below.

### Tests with Commercial Truck

### Pump: PTO Driven

### Action: Manual with and/or without Gear Engaged

TABLE 1
Nozzles Configuration

| | |
|---|---|
| A | 1 × NF 1500120 |
| | 1 × FF750145 |
| | 2 × MP312NN |
| B | 1 × NF 1500120 |
| | 1 × FF750145 |
| | 2 × MP312NN |
| | 1 × FF703145 |

TABLE 2
Truck Speed Evaluation

| | | | Time | | | | |
|---|---|---|---|---|---|---|---|
| RPM | GEAR | L (yd) | (sec) | y/min | m/min | mph | Kmh |
| 1,000 | 1 low | 170 | 150 | 68.00 | 62.18 | 2.32 | 3.73 |
| 1,000 | 2 low | 170 | 90 | 113.33 | 103.63 | 3.86 | 6.22 |
| 750 | 1 low | 170 | 200 | 51.00 | 46.63 | 1.74 | 2.80 |
| 750 | 2 low | 170 | 120 | 85.00 | 77.72 | 2.90 | 4.66 |

TABLE 3
Truck Tank Volume Evaluation

| | H axe | V axe | Length | Vol | |
|---|---|---|---|---|---|
| cm | 241 | 130 | 546 | 13,400 | liters |
| inches | 95 | 51 | 215 | 3,542 | Gal |

TABLE 4
Pump Evaluation

| | | | beginning | end | used | Time | Time | Output | Output |
|---|---|---|---|---|---|---|---|---|---|
| Solution | Nozzles | rpm | (gal) | (gal) | (gal) | (min:sec) | (sec) | (gal/sec) | (gal/min) |
| Water | A | 1,000 | 3,542 | 1,771 | 1,771 | 5:00 | 300 | 5.90 | 354 |
| Water | A | 750 | 3,542 | 1,771 | 1,771 | 5:30 | 330 | 5.37 | 322 |
| Water | B | 750 | 3,542 | 1,771 | 1,771 | 5:30 | 330 | 5.37 | 322 |

TABLE 5
Application Output

| | | | Spray | | | | | | |
|---|---|---|---|---|---|---|---|---|---|
| | | | width | Length | Surface | Surface | Surface | Output | Output |
| Rpm | Gear | nozzles | (m) | (m/min) | (m²/min) | (ft²/min) | (a/min) | (gpm) | (gpa) |
| 1,000 | 1 low | A | 16 | 62.18 | 995 | 10,703 | 0.25 | 354 | 1,441 |
| 1,000 | 2 low | A | 16 | 103.63 | 1,658 | 17,839 | 0.41 | 354 | 865 |
| 750 | 1 low | A | 16 | 46.63 | 746 | 8,027 | 0.18 | 322 | 1,747 |
| 750 | 2 low | A | 16 | 77.72 | 1,244 | 13,379 | 0.31 | 322 | 1,048 |
| 750 | 1 low | B | 16 | 46.63 | 746 | 8,027 | 0.18 | 322 | 1,747 |
| 750 | 2 low | B | 16 | 77.72 | 1,244 | 13,379 | 0.31 | 322 | 1,048 |

TABLE 6
Different Configurations

| | | | Dil. | | | | | | |
|---|---|---|---|---|---|---|---|---|---|
| | | | Rate | | | | | | |
| | | | Polymer | Target | Time/km | Area/cycle | Cycle | Cycle/day | Area/day |
| rpm | width | gear | Sol' + Water | GPA | (mins) | (acres) | (mins) | (11 h) | (acres) |
| 750 | 16 | 1^{st} | 1 + 3 | 400 | 20′ | 2.00 | 80 | 8 | 17 |
| 750 | 16 | 3^{rd} | 1 + 3 | 200 | 10′ | | | | |
| 750 | 16 | 5^{th} | 1 + 3 | 100 | 5′ | | | | |
| 750 | 8 | 1^{st} | 1 + 3 | 800 | 20′ | | | | |
| 750 | 16 | 1^{st} | 1 + 1 | 800 | 20′ | | | | |
| 750 | 16 | 3^{rd} | 1 + 1 | 400 | 10′ | | | | |

TABLE 7
Test Area

| | | | | | | | | | | Time | Total | | | |
|---|---|---|---|---|---|---|---|---|---|---|---|---|---|---|
| Length | Width | Surface | Polymer Sol' | | Width | | | | Speed | area | output | Water | Passes | Totes |
| (feet) | (feet) | (acre) | (gpa) | (gal/area) | (m) | rpm | gear | nozzles | (m/min) | (sec) | (gal/area) | (gal) | area | Units |
| 165 | 165 | 0.625 | 1,187 | 742 | 8 | 1,000 | 1 low | A | 62.18 | 305 | 1,801 | 1,059 | 6.6 | 2.7 |
| | | | | | 8 | 1,000 | 2 low | A | 103.63 | 183 | 1,081 | 339 | 6.6 | |
| | | | | | 8 | 750 | 1 low | A | 46.63 | 407 | 2,183 | 1,442 | 6.6 | |
| | | | | | 8 | 750 | 2 low | A | 77.72 | 244 | 1,310 | 568 | 6.6 | |
| | | | | | 8 | 750 | 1 low | B | 46.63 | 407 | 2,183 | 1,442 | 6.6 | |
| | | | | | 8 | 750 | 2 low | B | 77.72 | 244 | 1,310 | 568 | 6.6 | |

TABLE 8
Test Area

| | | | | | | | | | | Time | Total | | | |
|---|---|---|---|---|---|---|---|---|---|---|---|---|---|---|
| Length | Width | Surface | Polymer Sol' | | Width | | | | Speed | area | output | Water | Passes | |
| (feet) | (feet) | (acre) | (gpa) | (gal/area) | (m) | rpm | gear | nozzles | (m/min) | (sec) | (gal/area) | (gal) | area | Totes Units |
| 168 | 72 | 0.27768595 | 1,424 | 396 | 8 | 1,000 | 1 low | A | 62.18 | 305 | 1,801 | 1,406 | 6.6 | 1.5 |
| | | | | | 8 | 1,000 | 2 low | A | 103.63 | 183 | 1,081 | 685 | 6.6 | |
| | | | | | 8 | 750 | 1 low | A | 46.63 | 407 | 2,183 | 1,788 | 6.6 | |
| | | | | | 8 | 750 | 2 low | A | 77.72 | 244 | 1,310 | 915 | 6.6 | |
| | | | | | 8 | 750 | 1 low | B | 46.63 | 407 | 2,183 | 1,788 | 6.6 | |
| | | | | | 8 | 750 | 2 low | B | 77.72 | 244 | 1,310 | 915 | 6.6 | |

In light of the foregoing, it should be appreciated that the description herein of the various embodiments of the present invention is given for clearness of understanding only, and no unnecessary limitations should be understood therefrom, as modifications within the scope of the invention may be apparent to those having ordinary skill in the art.

What is claimed is:

1. An apparatus for applying multiple coatings of liquid onto an application surface in a single pass, the apparatus comprising:
a manifold comprising an inlet and a plurality of outlets;
a first nozzle coupled to a first outlet of the plurality of outlets, the first nozzle disposed at a first angle relative to a plane that is one of parallel and perpendicular to the application surface;
a second nozzle fluidly coupled to a second outlet of the plurality of outlets, the second nozzle disposed at a second angle relative to the plane, the second angle different than the first angle; and
a third nozzle fluidly coupled to a third outlet of the plurality of outlets, the third nozzle disposed at a third angle relative to the plane, the third angle different from at least one of the first angle and the second angle.

2. The apparatus of claim 1, wherein the second angle is greater than the first angle and the third angle is greater than the second angle.

3. The apparatus of claim 1, wherein the second angle and the third angle are substantially equal to each other.

4. The apparatus of claim 1, wherein the second nozzle is disposed above the first nozzle, and the third nozzle is disposed above the second nozzle.

5. The apparatus of claim 1, wherein the first nozzle is disposed above the second nozzle, and the third nozzle is disposed above the first nozzle.

6. The apparatus of claim 1, wherein the manifold is adapted to be disposed parallel to the application surface.

7. The apparatus of claim 6, wherein the manifold is adapted to be disposed perpendicular to the application surface.

8. The apparatus of claim 1, wherein the first nozzle defines a full cone spray pattern.

9. The apparatus of claim 1, wherein the second and third nozzles define fan spray patterns.

10. The apparatus of claim 1, wherein the plane is disposed parallel to the application surface and the first angle is in the range of approximately one degree to approximately thirty degrees below the plane.

11. The apparatus of claim 10, wherein the second angle is in a range of approximately thirty degrees to approximately eighty-five degrees above the plane.

12. The apparatus of claim 11, wherein the third angle is in a range of approximately ninety-five degrees to approximately one-hundred and thirty degrees above the plane.

13. The apparatus of claim 1, further comprising:
a vehicle;
a tank carried by the vehicle and storing the liquid; and
a pump in fluid communication with the tank for supplying the liquid to the manifold.

14. The apparatus of claim 13, wherein the second angle is greater than the first angle and the third angle is greater than the second angle.

15. The apparatus of claim 13, wherein the second angle and the third angle are substantially equal to each other.

16. The apparatus of claim 13, wherein the second nozzle is disposed above the first nozzle, and the third nozzle is disposed above the second nozzle.

17. The apparatus of claim 13, wherein the first nozzle is disposed above the second nozzle, and the third nozzle is dispose above the first nozzle.

18. The apparatus of claim 13, wherein the manifold is adapted to be disposed parallel to the application surface.

19. The apparatus of claim 13, wherein the manifold is adapted to be disposed perpendicular to the application surface.

20. The apparatus of claim 13, wherein the first nozzle defines a full cone spray pattern.

21. The apparatus of claim 13, wherein the second and third nozzles define fan spray patterns.

22. The apparatus of claim 13, wherein the plane is adapted to be disposed parallel to the application surface and the first angle is in the range of approximately one degree to approximately thirty degrees below the plane.

23. The apparatus of claim 22, wherein the second angle is in the range of approximately thirty degrees to approximately eighty-five degrees above the plane.

24. The apparatus of claim 23, wherein the third angle is in the range of approximately ninety-five degrees to approximately one-hundred and thirty degrees above the plane.

25. An apparatus for spraying multiple streams of at least one liquid from a storage tank onto an application surface, the apparatus comprising:
a manifold in fluid communication with the storage tank, the manifold comprising:
a first emission means for dispersing the liquid in accordance with a first spray pattern, the first spray pattern comprising a first droplet size and a first emission angle relative to a plane that is one of parallel and perpendicular relative to the application surface during use,
a second emission means for dispersing the liquid in accordance with a second spray pattern, the second spray pattern comprising a second droplet size and a second emission angle relative to the plane, the second droplet size greater than the first droplet size, and
a third emission means for dispersing the liquid in accordance with a third spray pattern, the third spray pattern comprising a third droplet size and a third emission angle relative to the plane, the third droplet size greater than the second droplet size.

26. The apparatus of claim 25, wherein the plane is disposed parallel to the application surface and the second emission angle is greater than the first emission angle and the third emission angle is greater than the second emission angle.

27. The apparatus of claim 25, wherein the plane is disposed parallel to the application surface and the first emission angle is approximately ninety degrees below the plane, the second emission angle is in the range of approximately five degrees to approximately sixty degrees below plane, and the third emission angle is in the range of approximately five degrees to approximately sixty degrees above the plane.

28. The apparatus of claim 25, wherein the first droplet size is approximately fifty microns, the second droplet size is approximately one-hundred and eighty-five microns, and the third droplet size is approximately three-hundred and thirty-five microns.

29. The apparatus of claim 25, wherein the second emission means is positioned above the first emission means relative to the plane, and the third emission means is positioned above the second emission means relative to the plane.

30. The apparatus of claim 25, wherein the first emission means is positioned above the second emission means relative to the plane and the third emission means is positioned above the first emission means relative to the plane.

31. The apparatus of claim 25, wherein the manifold is disposed parallel to the application surface.

32. The apparatus of claim 25, wherein the manifold is disposed perpendicular to the application surface.

33. The apparatus of claim 25, wherein the first, second, and third emission means comprise nozzles.

34. The apparatus of claim 25, further comprising:
a vehicle;
a tank carried by the vehicle and storing the liquid; and
a pump in fluid communication with the tank for supplying the liquid to the manifold.
